(19) United States
(12) Patent Application Publication
(10) Pub. No.: US 2015/0172925 A1
(43) Pub. Date: Jun. 18, 2015

(54) Method and Apparatus for Wireless Network Access Parameter Sharing

(71) Applicants: Tapani Antero Leppanen, Tampere (FI); Arto Tapio Palin, Viiala (FI); Jukka Pekka Reunamaki, Tampere (FI)

(72) Inventors: Tapani Antero Leppanen, Tampere (FI); Arto Tapio Palin, Viiala (FI); Jukka Pekka Reunamaki, Tampere (FI)

(21) Appl. No.: 14/396,472

(22) PCT Filed: Apr. 26, 2012
(86) PCT No.: PCT/FI2012/050414

§ 371 Date: Jan. 28, 2015

(51) Int. Cl. H04W 12/08; H04L 29/06

(52) U.S. Cl. CPC H04W 12/08; H04L 63/10

(57) ABSTRACT

In a non-limiting and example embodiment, a method is provided for controlling shared wireless network access parameters, including: receiving, by an apparatus, credentials for accessing to a wireless network, storing, by the apparatus, the credentials to a protected storage, and accessing the wireless network on the basis of the stored credentials, wherein the stored credentials are accessible by only predetermined trusted applications.

### FIELD

The present invention relates to facilitation sharing of wireless network access parameters.

### BACKGROUND

Local wireless networks, such as IEEE 802.11 WLANs or wireless wide area networks are widely used for local wireless Internet connectivity. Majority of private wireless network access points are protected, i.e. they can be hidden and require correct encryption key to be accessed. Various personal communications devices like mobile phones, tablets and laptops are having more and more nomadic users who use their devices increasingly at friends' homes, pubs, cafes and soon also e.g. in private cars. A cellular data connection can be slow, expensive and/or may not be supported.

It is desirable to easily get access rights for available wireless network access points also when a user is visiting a friend, for example. The user's friend is likely happy to allow the user to share his wireless network but most likely has security concerns about sharing required connection credentials. Most people do not want to open their network in order to maintain privacy, to avoid increased traffic on their internet connection or to protect from false accusations of piracy. Some advanced access points support separate guest access but these are not very common. Some expert users also set up a guest network with additional routers and access points. A password protected guest network still requires its owner to share the credentials to guests.

### SUMMARY

Various aspects of examples of the invention are set out in the claims.

According to a first embodiment, there is provided a method, comprising: receiving, by an apparatus, credentials for accessing to a wireless network, storing, by the apparatus, the credentials to a protected storage, and accessing the wireless network on the basis of the stored credentials, wherein the stored credentials are accessible by only predetermined trusted applications.

According to a second embodiment, there is provided a method, comprising: receiving, by an apparatus, identification information of a second apparatus requesting access to a wireless network, transmitting, by the apparatus, identification information of the second apparatus and at least one decryption parameter to a third apparatus controlling access to the wireless network, and transmitting, by the apparatus, encrypted credentials for accessing to the wireless network to the second apparatus.

According to a third embodiment, there is provided an apparatus configured to carry out the method of the first and/or second embodiment.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a wireless communications system;

FIG. 2 illustrates a method according to an embodiment;

FIG. 3 illustrates network information sharing architecture according to an embodiment;

FIG. 4 illustrates an example display view of a network sharing application;

FIG. 5 is an example signaling chart illustrating removal of credentials;

FIG. 6 illustrates a method according to an embodiment;

FIGS. 7a and 7b illustrate example display views of a network sharing client application;

FIG. 8 illustrates exchange of network credentials according to an embodiment;

FIG. 9 illustrates an example configuration for wireless network information sharing;

FIG. 10 is an example signaling chart for wireless network sharing; and

FIG. 11 illustrates a mobile communications device according to an embodiment.

### DETAILED DESCRIPTION

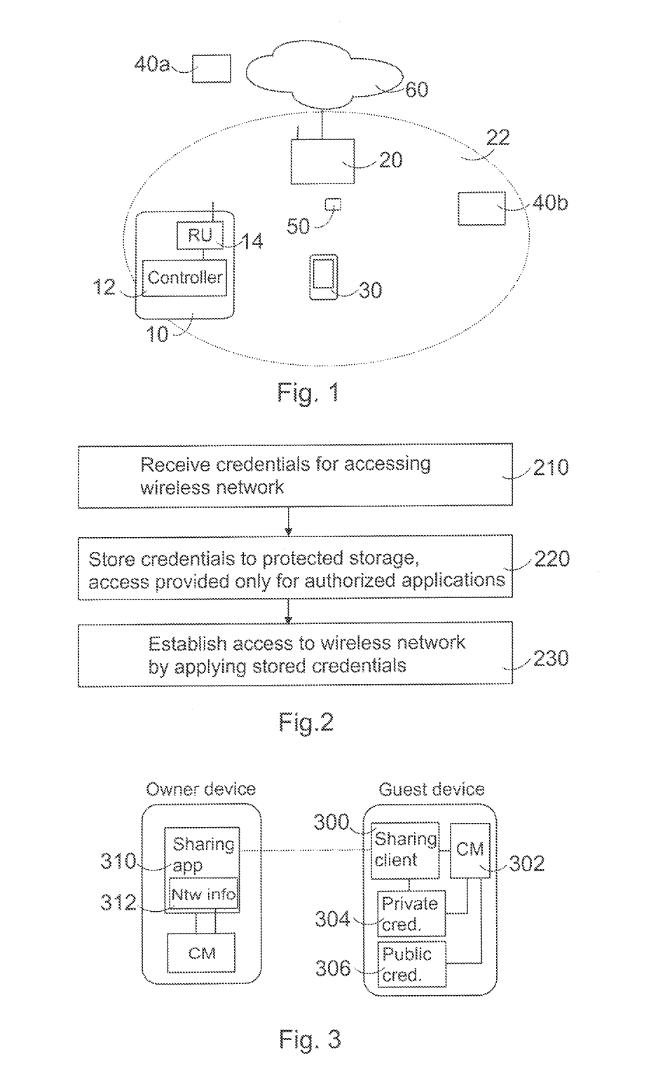

FIG. 1 illustrates an example of a wireless communication system including radio devices, such as devices supporting IEEE 802.11 features. While some wireless network sharing related embodiments are described below with reference to WLANs, it should be appreciated that other embodiments are applicable to sharing access to other wireless networks, such as wireless personal area networks (WPAN), wireless peer-to-peer networks, wireless mesh networks, and wireless wide area networks (WAN).

Mobile devices 10, 30 may associate with an access point (AP) or a base station 20. In some embodiments, the devices 10, 30 are IEEE 802.11 WLAN stations (STA) capable of establishing an infrastructure basic service set (BSS) with the AP 20. The AP 20 may be a fixed or mobile AP. The AP 20 typically provides access to other networks 60, e.g. the Internet. In another embodiment, an independent BSS (IBSS) or a mesh BSS (MBSS) is established without a dedicated AP, and in such embodiments the mobile device 10, 30 may be a non-access-point terminal station. There may also be other WLANs or other types of access networks, such as cellular networks, available for the devices 10, 30, via which remote devices 40a, such as network servers, may be connected. One or more further local devices, in the examples below also referred to as server, 40b may be connected to a locally available wired or wireless network.

The mobile device 10, referred hereafter as the guest device, may be visiting a coverage area 22 of the access point 20 owned by a user of mobile device 30, hereafter referred as the owner device. It is to be noted that the owner device herein generally refers to an apparatus which has required credentials, typically in clear text format, for connecting an access point, but the user of which does not necessarily have to actually own the access point.

Credentials for accessing a WLAN by establishing a connection with the AP may comprise at least one of a service set identifier, an encryption type indicator, and an encryption key. However, it is to be appreciated that these are just examples of applicable parameters and the term ‘credentials’ is herewith used broadly to refer to any required parameters required for enabling access to a wireless network. An owner of a wireless network often is not willing to share his network and credentials due to security concerns, does not know the required credentials or is not aware how to setup connection credentials into a device. It is generally desirable to have an easy and trusted method to give and get access to protected wireless networks, such as WLAN access points.

According to some embodiments of the present invention, credentials are stored in access-protected manner in an apparatus 10 visiting a wireless network. FIG. 2 illustrates a method according to some embodiments. The method may be applied as a control algorithm in an apparatus, such as the guest device 10.

Credentials for accessing to a wireless network are received 210. The guest device 10 may receive the credentials from a second apparatus, such as an owner's device 30, a tag 50, or a server 40a, 40b. The received credentials are stored 220 to a protected storage. This refers generally to the storing of the credentials in a protected manner, including any suitable technique enabling limited access to the credentials parameters, such as use of encryption, hidden storage area, or access-controlled storage area/position.

The stored credentials are accessible by only predetermined trusted applications. The term ‘application’ is to be understood broadly, and may refer e.g. to lower-level software or an application instance. In one embodiment, the credentials are provided only to lower level connectivity management software when access to the wireless network is needed. The credentials can be made private and not available for other high level applications. In particular, the credentials may be stored such that they are not made visible in the user interface of the guest device.

When required, such trusted application retrieves 230 the credentials and the wireless network is accessed on the basis of the stored credentials. The method of FIG. 2 enables to provide reasonable trust for the wireless network owner that the credentials cannot be forwarded to unauthorized parties.

As indicated in FIG. 1, the mobile device 10 may comprise a controller 12 connected to a radio unit (RU) 14. The controller 12 may be configured to control at least some of the features illustrated in FIG. 2. An apparatus comprising the controller 12 may also be arranged to implement at least some of the further related embodiments illustrated below.

With reference to FIG. 3, the mobile device 10 functioning as the guest device, and the controller 12 thereof, may encompass a sharing client 300 arranged to receive 210 the credentials and store 220 the credentials to the protected storage 304. The sharing client 300 may also control access to the stored credentials. Such private wireless network parameters 304 may be separated from public wireless network parameters 306, such as guest's own WLAN and open WLANs.

The client application 300 may communicate with a sharing service/server application 310 in the owner device 30. The sharing service application 310 may collect the network credentials which are delivered for the sharing client 300. In some embodiments, the client application 300 receives the credentials directly from the sharing service application 310.

In some embodiments, the predetermined trusted applications comprise the sharing client application 300 for wireless network sharing and a connectivity management (CM) application 302. The CM application 302 establishes a connection to the access point 20 on the basis of the credentials received from the protected storage 304.

The client application 300 may be arranged to prevent the display of the credentials to the user, i.e. does not reveal the credentials in a user interface of the guest device 10. This may be arranged by actively preventing (plain text) display of the credentials or by storing the credentials such that an application with a display view cannot access the credentials, for example. The credentials storage area 304 of the stored credentials may be hidden. Thus, the protected storage of the credentials may be based on preventing the non-authorized application from finding the credentials.

In some embodiments, the credentials are applied in encrypted form. The credentials may be encrypted for the transmission and/or for the storage 304. For example, the encrypted credentials may be offered for each guest device, but in order to use the credentials, a decryption key needs to be obtained from another device configured to control access to the wireless network. In another embodiment, the sharing client 300 may encrypt the credentials and store the encrypted credentials.

It is to be noted that an apparatus may often comprise both the sharing client 300 and the sharing service application 310. For example, it may be that the sharing client 300, the sharing service application 310, and/or the CM application 302 are implemented in a common executable program, or in separate executable programs.

In some embodiments, the sharing service application 310 defines which wireless networks are available for sharing on the basis of checking to which wireless networks the host owner device 30 is connected to, checking wireless networks for which the owner device has credentials, and/or checking which wireless networks are preconfigured to be shareable, for example.

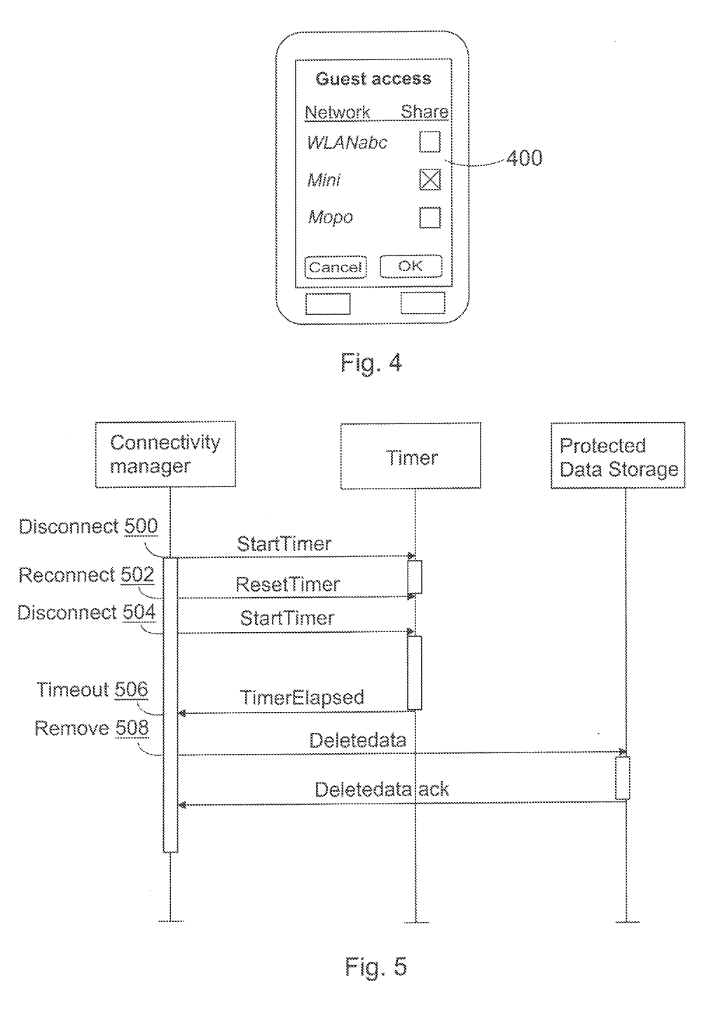

Referring now to FIG. 4, the sharing service application 310 may have a user interface 400 which allows the owner to easily specify which WLAN access point credentials configured in the device can be shared to other devices. In the example UI view of FIG. 4 the owner has allowed sharing of a WLAN network identified as “Mini”.

The sharing service application 310 can utilize the network configuration 312 of the owner device 30. For example, the owner may decide to share all WLAN access points 20 which are readable in the network configuration 312. It is to be noted that the owner device 30 may also comprise, in a protected storage, private network information, which may not be shared further. After the user has authorized sharing, the sharing application 310 may be configured to read this information automatically. Thus, the owner does not have to find network parameter configuration in order to provide access to her friend. This sharing can be set to be active all the time, and credentials may be automatically provided for an authorized guest device 10 upon a later visit.

The user interface of the owner device 30 may provide an input mode allowing a user to specify users allowed to share the wireless network and receive the credentials. Allowed guest identifiers are stored in the memory of the owner device, the allowed guest identifiers being associated with apparatuses for which sharing of the wireless network is allowed on the basis of user inputs to the user interface. The sharing service application 310 may check the stored guest identifiers in response to receiving a guest access request from the guest device 10. The sharing service application 310 may automatically transmit the encrypted credentials for the guest device 10 and the sharing client 300 if an identifier associated with the guest device 10 is stored in the guest identifiers. For example, allowed guests may be selected/entered by applying a contact book of the owner device 30, from a social media service/application, etc.

The sharing client application 300 may inform a user of the apparatus of available wireless networks. The sharing client application 300 may request the credentials after receiving user's input for accessing an available wireless network. The sharing client application 300 may be arranged to automatically take care of any necessary actions for obtaining and setting the required wireless network access configuration, and trigger establishment of a connection to the wireless network AP 20. This substantially facilitates use of protected networks for non-professional users.

The sharing service application 310 may be configured to check if the guest device 10 comprises a trusted sharing client application, such as the sharing client application 300 of FIG. 3, configured to allow access to stored credentials only for predetermined trusted applications. The check may be performed on the basis of application identification information or certificate from the guest device 10, for example. If the service application 310 detects that the guest device 10 comprises the trusted sharing client application, it allows transmission of the credentials to the second apparatus.

When the guest device 10 is no longer connected to the wireless network, the stored credentials may be removed automatically by the sharing client application 300 or the CM SW 302. The credentials may be prevented from being used or removed from the protected storage 304 after detecting one or more triggers for removal, such as detecting the apparatus disconnecting from the wireless network, detecting expiry of a validity period of the credentials, and/or detecting that a credentials refreshment message or an authorization message (from the owner device or a further device controlling use of the credentials) has not been received. The sharing application 310 may also be configured to cause removal of the credentials in the guest device 10 by sending a control message to the sharing client 300. A user interface of the guest apparatus 10 and/or the owner device 30 may further provide an option for a user to cause removal of the credentials in the protected storage 306.

A predefined disconnection time period may be applied before the credentials are deleted after detecting the removal trigger, to prevent accidental removal. For example, the sharing client 300 may be configured to remove the WLAN credentials in the protected storage 304 one hour or one day after detecting the trigger. FIG. 5 is an example signalling chart in which a Connectivity Manager, such as the CM 302 of FIG. 3, controls the removal of the credentials. A timer is started in response to detecting disconnection 500 from the visited AP 20. The AP is reconnected 502, whereby the timer is reset. The AP 20 is again disconnected 504, and the timer is started. In response to detecting 506 timeout, the credentials are deleted 508.

After removal of the credentials, the guest device 10 needs to again connect the owner device 30 and may need to be authenticated in order to use the wireless network. However, the sharing application 310 may enable the owner to set a permanent access for the guest device, whereby the credentials are maintained in the protected storage. In an alternative embodiment, the sharing client 300 or sharing service application 310 performs the features of the Connectivity Manager in FIG. 5.

There are many options for implementing the credentials sharing from the owner device 30 to the guest device 10, some of which are further illustrated below.

The guest device 10 may first receive, in block 210 of FIG. 2 or already earlier, wireless network sharing information from a second apparatus, such as the mobile device 30, a tag 50 configured by a network owner, or a server 40a, 40b. This network sharing information may be sent upon request by the guest device 10, periodically as advertisement messages, and/or upon detecting a new guest device. The network sharing information may comprise wireless network identification information, some or all credentials required for accessing the wireless network, an indication that sharing of the wireless network is allowed, and/or information on a third apparatus which needs to be accessed for getting access to the wireless network, for example.

On the basis of the received sharing information, the guest device 10 may request the credentials and/or access authorization from a third apparatus, such as the server 40a, 40b or the owner device 30. In another embodiment, the guest device 10 requests from the third device security parameters for using received credentials. In a still further embodiment, some credentials are received from the owner device and some from the server.

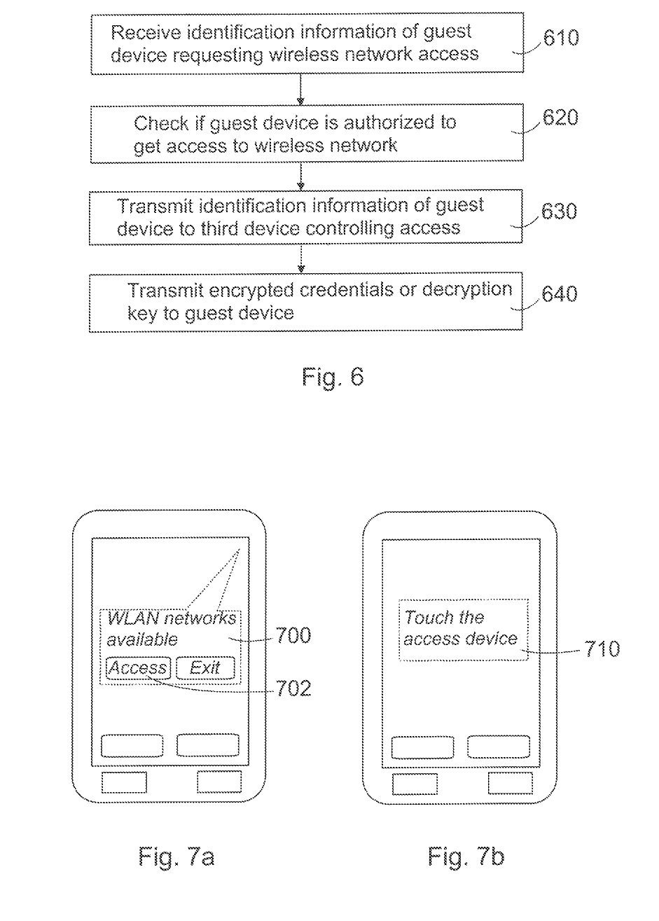

FIG. 6 illustrates a method according to an embodiment for an apparatus controlling access to the wireless network, such as the owner device 30 or the AP 20 communicating with the guest apparatus 10 operating as illustrated above.

Identification information of a guest device 10 requesting access to a wireless network is received 610. Authorization of the guest device 10 to access the wireless network is checked 620. This check may be performed automatically by checking if an identifier of the guest device is in a pre-stored list of authorized devices and/or prompting the user of the owner device to determine if the guest device is authorized.

If the guest device 10 is authorized to access the wireless network, identification information of the guest device is transmitted 630 to the third apparatus further applied for controlling access to the wireless network. Encrypted credentials are transferred 640 to the guest device. The message to the guest device 10 may also comprise an indication or address of the third apparatus. The guest device may, after receiving the encrypted credentials, request authorization and receive the decryption key from the third apparatus. The decryption parameter may be submitted to the third apparatus in connection with block 630 or already earlier.

In an alternative embodiment, in block 630 encrypted credentials for accessing the wireless network are transmitted to the third apparatus 40a, 40b and the decryption key is transferred 640 to the guest device 10.

The guest device 10 may be communicating with different radio connections with the owner device 30 and the third apparatus 40a, 40b. Examples of suitable connections include, but are not limited to, a near-field connection (NFC) to a mobile communications device or a tag, a Bluetooth connection to a mobile communications device, and a wireless local area network connection to a mobile communications device. In a further example, the third apparatus may be a remote server 40a, in which case the guest device may communicate with the server via a cellular connection.

Let us now further study some more detailed example embodiments related to the limited sharing of wireless network access credentials. One or more of these further illustrated features, in various combinations, may be applied in an apparatus configured to carry out features of FIG. 2 and/or 6.

In one example, the network sharing is provided by applying a Bluetooth (BT) service waiting for a connection. For example, sharing service information may be indicated in a BT Extended Inquiry Response field, which enables to speed up the discovery process.

In some embodiments the credentials are allowed and/or provided for the guest device 10 after the guest device is brought in a touch detection proximity to an apparatus comprising the sharing service application, such as the owner device 30. The touch detection proximity generally refers to sensing the devices to be very close to each other (contactless) or physically touching each other. For example, the touch detection proximity may refer to proximity enabling NFC connectivity.

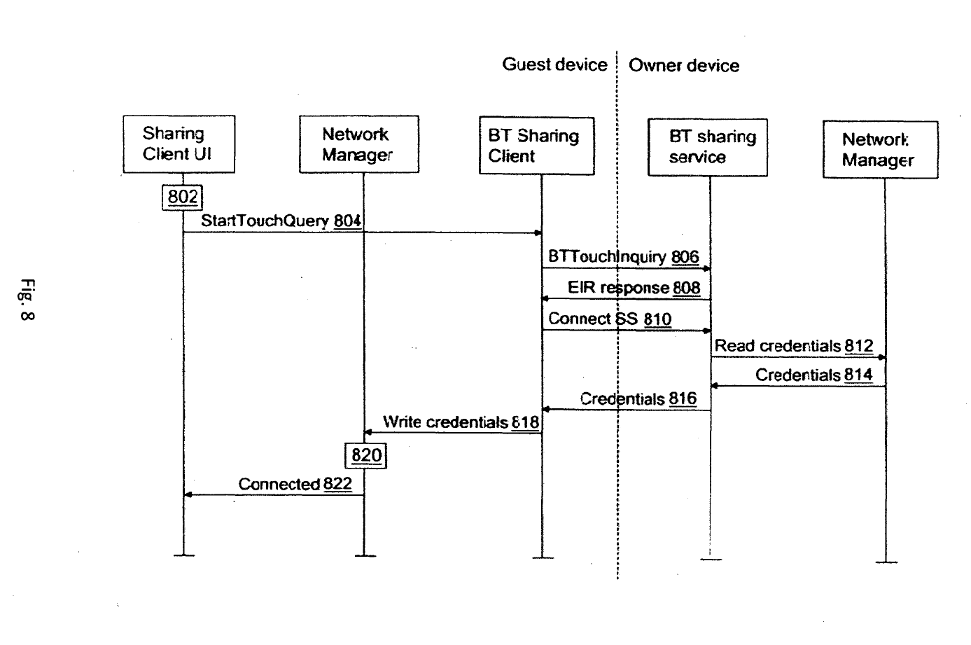

An example of application of touch detection is illustrated in FIGS. 7a and 7b. The client application 300 may display a UI element 700 for the guest device user enabling the user to simply select access 702 to an available WLAN. Upon detecting the user input for getting access to the WLAN, the guest device 10 may begin to search for devices in close proximity and the sharing client application may advice 710 the user to touch the owner's device 30 with the guest device 10.

In another example, the network sharing is further facilitated such that credentials are provided when the guest device 10 is detected to touch the owner device 30, without requiring UI actions from the user. This may be done without having a priori knowledge on WLAN existence.

According to an embodiment, BT based proximity detection is applied for arranging sharing of credentials. The BT touch enables to detect another BT device in touch detection proximity, on the basis of received signal strength information (RSSI) associated with received BT responses from neighbouring BT devices.

An embodiment applying BT touch features is further illustrated in FIG. 8. When the sharing client 300 has detected 802 a need for accessing an available WLAN, e.g. the user has selected “Access” 702 in the UI of FIG. 7a, it connects to a Bluetooth sharing client and initiates a BT touch inquiry by sending a StartTouchQuery 804. A BT touch inquiry 806 is sent and inquiry responses 808 are filtered according to RSSI levels. When an owner device is found with RSSI level above a predefined threshold value, which may be set so that touch is required, a connection is established to the owner device. The connection 810 is to a Bluetooth sharing service (SS) and the service is reading 812, 814 the credentials from the Network Manager SW. The credentials data may be encrypted by the sharing service. The credentials data is delivered 816 to the sharing client, which may decrypt the data and save 818 the credentials to the protected storage as private credentials. The Network Manager may access the stored credentials and establish 820 a wireless network connection with the credentials. The user is informed 822 of the established connection.

Similar operation can be carried out by NFC, in which case the credentials may be transferred by applying NFC Wi-Fi protected setup between NFC peers in the devices. The received data may be recognised as WLAN data, and may be stored to the protected storage and used similarly as illustrated above.

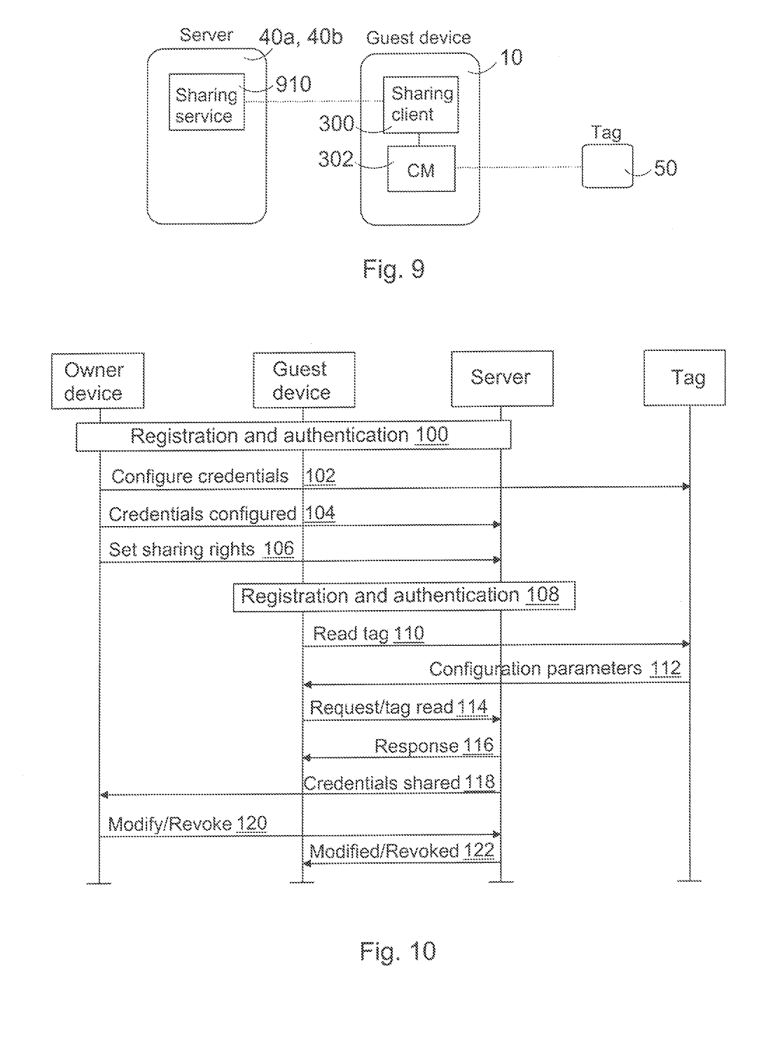

In some embodiments, a tag or other type of further data storage unit is applied for wireless network sharing. FIG. 9 illustrates an example system configuration where wireless network credentials are stored to a tag 50 accessible by the guest device 10 via a NFC connection, for example. A server 40a, 40b comprises a sharing service 910 controlling access to the wireless network remotely or locally. The sharing service 910 may be configured to perform similar features as illustrated above for the sharing service application 310 of FIG. 3. The server may be configured to perform at least some network sharing related actions on behalf of the owner device 30.

In some embodiments distribution of network access credentials is arranged without the presence of owner. This may be is achieved by using local data storage and server components, such as those illustrated in FIG. 9. The local data storage may be used to provide some of the required access parameters and information needed to receive missing parameters from the server in a secure manner. The server may be used to verify that the guest device 10 has rights to receive the remaining parameters for network access and later to manage access right in devices.

FIG. 10 provides an example on arranging network sharing for a system illustrated in FIG. 9. The owner device 30 may register and authenticate 100 itself to the server 40a, 40b. The owner device 30 configures 102 at least some wireless network access related parameters to the local data storage, the tag 50 in the example flow. In the present example, these access parameters include network identifier and other parameters, such as an encryption key to decrypt a secret access key from the server, validity time of the access key, a secret validity key, etc. The owner device 30 may also specify the server identifier or address to the tag.

The owner device 30 informs 104 the server that the local data storage has been configured with the parameters. The owner device 30 also informs the server of other parameters required for accessing the wireless network, such as the network access credentials, which may be encrypted by the secret key stored in the tag. The owner device 30 may optionally set 106 additional access sharing right parameters to the server, e.g. send identification on allowed guest device(s) 10 (if not already done in block 100).

The guest device 10 requiring network access may register and authenticate 108 to the server, if not already done. When the guest device 10 is in proximity to the tag, the guest device 10 accesses 110 the tag storage and receives 112 the network access parameters. The link over which the parameters are shared can be encrypted.

The guest device 10 connects 114 the server and requests access to received network by sending some or all information received from the tag. The server decides based on its configuration and information from the guest device 10, such as the secret validity key, whether the remaining parameters needed for network access are delivered for the guest device 10. The server may then notify 118 the guest device 10 that the network access is shared.

The owner device 30 may modify 120 access rights and/or network credentials later. The changes are reflected 122 to the devices having network access, such as the guest device 10. The credentials in the protected storage may be deleted in response to a removal request from the server 40a, 40b, for example.

The secret validity key may be an encryption key, such as a public key encryption key used to decrypt credentials received from the server, enabling to keep the network access parameters unreadable even for the server. Alternatively, the secret validity key may be a password used to identify that the device is not just trying to get access with network identifier.

The guest device 10 may be required to check or renew its permission from the service 910 at defined time instants. This allows controlling of the sharing after sharing has been performed. The service 910 may collect statics about when and which user has used the access point, enabling the owner to follow the guest access usage.

In an alternative embodiment, the local data storage 50 can contain all needed parameters for network access, and the guest device 30 may only inform the server 40a, 40b that it has received the parameters. However, better security level is achievable by granting key components to network access only to devices having both the valid access to the server and the valid secret from the local data storage. In a still further alternative embodiment, the credentials may be received from the tag in the encrypted format and the return information from the server may in this case be the required key for decrypting credentials.

Embodiments of the present invention and means to carry out these embodiments in an apparatus, such as the mobile device 10, 30 and/or server 40a, 40b, may be implemented in software, hardware, application logic or a combination of software, hardware and application logic. In an example embodiment, the application logic, software or an instruction set is maintained on any one of various conventional computer-readable media. It is to be noted that at least some of the above-illustrated features may be applied in devices configured to operate as wireless network access point 20, such as an IEEE 802.11 WLAN AP. For example, at least some of the above-illustrated server features and the sharing service 410 may be arranged in such apparatus. In another example, a mobile terminal device, such as the owner device 30, may be arranged to operate also as a wireless network access point.

In one example embodiment, there may be provided circuitry configured to provide at least some functions illustrated above, such as the features illustrated in FIG. 2 and/or 6. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although single enhanced entities were depicted above, it will be appreciated that different features may be implemented in one or more physical or logical entities. For instance, the apparatus may comprise a specific functional module for carrying one or more of the blocks in FIG. 2 and/or 6. In some embodiments, a chip unit or some other kind of hardware module is provided for controlling a radio device, such as the mobile device 10, 30.

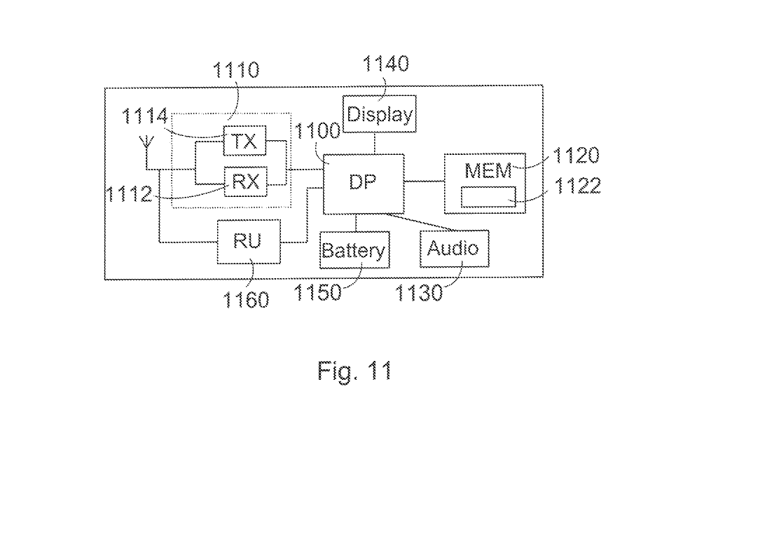

FIG. 11 is a simplified block diagram of high-level elements of a mobile communications device according to an embodiment. The device may be configured to carry out at least some of the functions illustrated above for the mobile device 10 and/or 30.

In general, the various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 1100 with at least one data processor and a memory 1120 storing a program 1122. The memory 1120 may be implemented using any data storage technology appropriate for the technical implementation context of the respective entity. By way of example, the memory 1120 may include non-volatile portion, such as electrically erasable programmable read only memory (EEPROM), flash memory or the like, and a volatile portion, such as a random access memory (RAM) including a cache area for temporary storage of data. The DP 1100 can be implemented on a single-chip, multiple chips or multiple electrical components. The DP 1100 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 1110 with a transmitter 1114 and a receiver 1112. However, it will be appreciated that the device is typically a multimode device and comprises one or more further radio units 1160, which may be connected to the same antenna or different antennas. By way of illustration, the device may comprise radio units 1110 to operate in accordance with any of a number of second, third and/or fourth-generation communication protocols or the like. For example, the device may operate in accordance with one or more of GSM protocols, 3G protocols by the 3GPP, CDMA2000 protocols, 3GPP Long Term Evolution (LTE) protocols, wireless local area network protocols, such as IEEE 802.11 or 802.16 based protocols, short-range wireless protocols, such as the Bluetooth, NFC, ZigBee, Wireless USB, and the like.

The DP 1100 may be arranged to receive input from UI input elements, such as an audio input circuit connected to a microphone and a touch screen input unit, and control UI output, such as audio circuitry 1130 connected to a speaker and a display 1140 of a touch-screen display. The device also comprises a battery 1150, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 11. For example, the device may comprise a power amplification chip for signal amplification, a baseband chip, and possibly further chips, which may be coupled to one or more (master) data processors.

An embodiment provides a computer program embodied on a computer-readable storage medium. The program, such as the program 1122 in the memory 1120, may comprise computer program code configured to, with the at least one processor, cause an apparatus, such as the device 10, 20, 30 or the device of FIG. 11, to perform at least some of the above-illustrated wireless network access parameter sharing related features illustrated in connection with FIGS. 2 to 10. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 11. A computer-readable medium may comprise a tangible and non-transitory computer-readable storage medium that may be any media or means that can contain or store the instructions for use by or in connection with an instruction execution system, apparatus, or device, such as a computer.

Although the specification refers to “an”, “one”, or “some” embodiment(s) in several locations, this does not necessarily mean that each such reference is to the same embodiment(s), or that the feature only applies to a single embodiment. Single features of different embodiments may also be combined to provide other embodiments. If desired, at least some of the different functions discussed herein may be performed in a different order and/or concurrently with each other. Furthermore, if desired, one or more of the above-described functions may be optional.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-53. (canceled)

54. A method, comprising:
receiving, by an apparatus, credentials for accessing to a wireless network,
storing, by the apparatus, the credentials to a protected storage, and
accessing the wireless network on the basis of the stored credentials, wherein the stored credentials are accessible by only predetermined trusted applications.

55. The method of claim 54, wherein the credentials are in encrypted form and received from a second apparatus,
at least one decryption parameter is received by the apparatus from a third apparatus, and
the encrypted credentials are decrypted based on the at least one decryption parameter.

56. The method of claim 54, wherein the apparatus receives wireless network sharing information from a second apparatus,
the apparatus requests credentials from a third apparatus on the basis of the received sharing information, and
the apparatus receives the credentials from the third apparatus.

57. The method of claim 55, wherein the apparatus is communicating with a first radio technology with the second apparatus and with a second radio technology with the third apparatus.

58. The method of claim 54, wherein storage area of the stored credentials is hidden and the display of the credentials in a user interface of the apparatus is prevented.

59. The method of claim 54, wherein the credentials are wireless local area network credentials comprising at least one of a service set identifier, encryption type, and an encryption key.

60. The method of claim 54, wherein the stored credentials are prevented from being used or removed from the protected storage area after at least one of detecting the apparatus disconnecting from the wireless network, detecting expiry of a validity period of the credentials, detecting a command for removing the credentials, and detecting that a credentials refreshment message or an authorization message has not been received.

61. A method, comprising:
receiving, by an apparatus, identification information of a second apparatus requesting access to a wireless network,
transmitting, by the apparatus, identification information of the second apparatus and at least one decryption parameter to a third apparatus controlling access to the wireless network, and
transmitting, by the apparatus, encrypted credentials for accessing to the wireless network to the second apparatus.

62. The method of claim 61, wherein a user confirmation for sharing network access credentials to the second apparatus is requested from a user of the apparatus by a network access sharing application, and
the encrypted credentials are transmitted to the second apparatus in response to detecting the user confirmation.

63. The method of claim 61, wherein the apparatus comprises a user interface mode enabling a user of the apparatus to specify users allowed to share the wireless network,
allowed guest identifiers are stored in the memory of the apparatus, the allowed guest identifiers being associated with apparatuses for which sharing of the wireless network is allowed on the basis of user inputs to the user interface,
the apparatus checks the stored allowed guest identifiers in response to receiving a guest access request from the second apparatus, and
the apparatus automatically transmits the encrypted credentials to the second apparatus in response to an identifier associated with the second apparatus being stored in the guest identifiers.

64. The method of claim 61, wherein the apparatus comprises a sharing application configured to:
check if the second apparatus comprises a trusted sharing client application configured to allow access to stored credentials only for predetermined trusted applications, and
allow transmission of the credentials to the second apparatus in response to detecting that the second apparatus comprises the trusted sharing client.

65. The method of claim 61, wherein the credentials are wireless local area network credentials comprising at least one of a service set identifier, encryption type, and an encryption key.

66. The method of claim 61, wherein the apparatus transmits to the third apparatus at least one parameter for controlling validity of the delivered credentials, wherein the at least one parameter comprises at least one of information indicating how long the credentials are valid, information indicating that all or a subset of allowed devices are not any more allowed to use the credentials, and information indicating need for periodic reauthorization of the credentials.

67. An apparatus, comprising:
at least one processor; and
at least one memory including computer program code,
the at least one memory and the computer program code configured to, with the at least one processor, cause the apparatus at least to:
receive credentials for accessing to a wireless network,
store the credentials to a protected storage, and
access the wireless network on the basis of the stored credentials, wherein the stored credentials are accessible by only predetermined trusted applications.

68. The apparatus of claim 67, wherein the credentials are in encrypted form and from a second apparatus,
the apparatus is configured to receive at least one decryption parameter from a third apparatus, and
the apparatus is configured to decrypt the encrypted credentials based on the at least one decryption parameter.

69. The apparatus of claim 67, wherein the apparatus is configured to receive wireless network sharing information from a second apparatus,
the apparatus is configured to request credentials from a third apparatus on the basis of the received sharing information, and
the apparatus is configured to receive the credentials from the third apparatus.

70. The apparatus claim 68, wherein the apparatus is configured to communicate with a first radio technology with the second apparatus and with a second radio technology with the third apparatus.

71. The apparatus of claim 67, wherein storage area of the stored credentials is hidden and the display of the credentials in a user interface of the apparatus is prevented.

72. The apparatus of claim 67, wherein the credentials are wireless local area network credentials comprising at least one of a service set identifier, encryption type, and an encryption key.

73. The apparatus of claim 67, wherein the apparatus is configured to remove the stored credentials from the protected storage area after at least one of detecting the apparatus disconnecting from the wireless network, detecting expiry of a validity period of the credentials, detecting a command for removing the credentials, and detecting that a credentials refreshment message or an authorization message has not been received.

74. An apparatus, comprising:
at least one processor; and
at least one memory including computer program code,
the at least one memory and the computer program code configured to, with the at least one processor, cause the apparatus at least to:
receive identification information of a second apparatus requesting access to a wireless network,
transmit identification information of the second apparatus and at least one decryption parameter to a third apparatus controlling access to the wireless network, and
transmit encrypted credentials for accessing to the wireless network to the second apparatus.

75. The apparatus of claim 74, wherein the apparatus comprises a network access sharing application configured to request a user confirmation for sharing network access credentials to the second apparatus, and
the apparatus is configured to transmit the encrypted credentials to the second apparatus in response to detecting the user confirmation.

76. The apparatus of claim 74, wherein the apparatus comprises a user interface mode enabling a user of the apparatus to specify users allowed to share the wireless network,
the apparatus is configured to store allowed guest identifiers in the memory of the apparatus, the allowed guest identifiers being associated with apparatuses for which sharing of the wireless network is allowed on the basis of user inputs to the user interface,
the apparatus is configured to check the stored allowed guest identifiers in response to receiving a guest access request from the second apparatus, and
the apparatus is configured to automatically transmit the encrypted credentials to the second apparatus in response to an identifier associated with the second apparatus being stored in the guest identifiers.

77. The apparatus of claim 74, wherein the apparatus comprises a sharing application configured to:
check if the second apparatus comprises a trusted sharing client application configured to allow access to stored credentials only for predetermined trusted applications, and
allow transmission of the credentials to the second apparatus in response to detecting that the second apparatus comprises the trusted sharing client.

78. The apparatus of claim 74, wherein the credentials are wireless local area network credentials comprising at least one of a service set identifier, encryption type, and an encryption key.

79. The apparatus of claim 74, wherein the apparatus is configured to transmit at least one parameter to the third apparatus for controlling validity of the delivered credentials, wherein the at least one parameter comprises at least one of information indicating how long the credentials are valid, information indicating that all or a subset of allowed devices are not any more allowed to use the credentials, and information indicating need for periodic reauthorization of the credentials.
